(19) United States
(12) Patent Application Publication
(10) Pub. No.: US 2002/0052180 A1
(43) Pub. Date: May 2, 2002

(54) System and method for mobility management for a satellite based packet data system

(75) Inventors: Channasandra Ravishankar, Germantown, MD (US); Saurabh Garg, Uttar Pradesh (IN); Trevor Eagling, Frederick, MD (US); Mike Darcy, Potomac, MD (US)

Correspondence Address: Hughes Electronics Corporation, Patent Docket Administration, P.O. Box 956, Bldg. 1, Mail Stop A109, EL Segundo, CA, 90245-0956, US

(73) Assignee: HUGHES ELECTRONICS

(21) Appl. No.: 09/923,837

(22) Filed: Aug. 7, 2001

Related U.S. Application Data
(60) Provisional application No. 60/224,030, filed on Aug. 9, 2000.

(51) Int. Cl. H04B 7/185

(52) U.S. Cl. 455/12.1; 455/445; 455/456; 455/427

(57) ABSTRACT

In a medium earth orbit (MEO) satellite system, an embodiment of the present invention employs a system and method for administering mobility management issues for mobile terminals, via a network of base station controllers. The mobility management issues, for example, paging, routing, and handover of communication signals are administered between the base station systems without having to be routed through the serving general packet radio service support node (SGSN).

The present invention claims benefit under 35 U.S.C. section 119(e) of a provisional U.S. Patent Application of Channasandra Ravishankar et. al., entitled ICO Packet Data Mobility Management and Handover, Serial No. ______ , filed Aug. 9, 2000, the entire contents of said provisional application being incorporated herein by reference.

### BACKGROUND OF THE INVENTION

1. Field of the Invention

The present invention relates generally to a system and method for administering mobility management for mobile terminals (e.g. registration, handover, paging and routing), within a satellite network, such as a medium earth orbit (MEO) satellite network. More particularly, the present invention relates to a system and method employing a plurality of MEO satellites, for example, within a Global System for Mobile Communications-General Packet Radio Service (GSM-GPRS) network that enables management of communication signals between multiple base station controllers.

2. Description of the Related Art

A satellite-based communications network, such as a telephony network or data transmission network, typically employs at least one base station, one or more satellites, such as a medium earth orbit (MEO) satellite, and a plurality of mobile terminals, such as remote telephones or data terminals. In a typical network, data is transmitted between the mobile terminals and base stations in the form of packets or frames, as can be appreciated by one skilled in the art. The satellite network, as described herein, shares a similar protocol process with the GSM-GPRS standard. Accordingly, this allows compatibility between the satellite, cellular and the Public Switched Telephone Network (PSTN) systems. However, the satellite air-interface poses physical constraints not accounted for in the basic terrestrial GSM-GPRS architecture.

The GSM-GPRS network permits transmission and reception of data and voice information across a mobile terminal network, wherein the mobile terminals comprise remote telephones and data terminals, as described above. In addition the mobile terminals transmit and receive signaling information corresponding to voice and data communication services. The GSM-GPRS network facilitates instant connections between mobile terminals and a fixed network, for example an internet service provider (ISP), and between two mobile terminals, thereby no longer requiring a dial-up modem or other physical connection. In addition, the GSM-GPRS network employs packet switching, thus ensuring spectrum efficiency. Accordingly, system resources are employed only when sending and receiving information, therefore, allowing users to share network resources, as can be appreciated by one skilled in the art.

One disadvantage of employing terrestrial GSM-GPRS protocol for a non-geosynchronous satellite system relates to the terrestrial protocol's static nature. The association between cells corresponding to radio coverage areas remain fixed in a terrestrial network. Accordingly, a mobile terminal (MT) in a terrestrial GSM-GPRS system is associated uniquely with a geographical area (e.g., a cell) on the earth, depending on the radio frequency and the associated base transceiver station (BTS), that the MT employs to communicate with the base station. In a Medium Earth Orbit (MEO) satellite environment, multiple spot beams from different satellites are projected on an MT as the MEO satellites move with respect to the surface of the earth. Multiple base stations controllers (BSC) control the multiple spot beams. Furthermore, the initial BSC may relinquish control of the MT to another BSC as the satellites orbit and the spot beams change location despite the static position of the MT. Therefore, the MT may communicate with multiple BSCs due to the satellites' movement, despite the MT remaining in the same geographic position. In addition, multiple network elements correspond to varying radio coverage areas. Accordingly, a Serving GPRS support node (SGSN) services multiple radio coverage areas. Therefore, a need exists for a management system for the dynamic elements (e.g. BSC, spot beams) within a MEO satellite communication system.

In the GSM-GPRS network, geographical coverage areas of the radio services spectrum are divided into cells. The cells are further regrouped into routing areas for providing and managing network services. By contrast, within the MEO environment, a network operator divides geographical coverage locations into Service areas. Multiple service areas form service regions. The network operator assembles the above mentioned groupings based on service logic (e.g., a base station associated with a corresponding SGSN (Serving GPRS Support Node) which in turn services a particular area) and international regulations, as well as radio spectrum planning. Accordingly in a terrestrial GPRS system, unless the MT moves, data to and from the MT is routed to and from the SGSN to which the base station (communicating with the MT) is attached, in a conventional manner. By contrast, in a MEO system, even when the MT does not move, it may be necessary to route data to and from the MT as well as to and from an SGSN that is not directly attached to the base station with which the MT is communicating due to the service logic and international regulations. Therefore, a need exists for a method for managing signal routing within a MEO satellite communications network that accounts for service logic, and regulatory requirements.

A single BSC also administers paging of an MT within a GSM-GPRS network. Paging is performed based on Location Area (LA) for circuit switched services and Routing Area (RA) based on packet switched services, in a conventional manner. However, this type of paging is only adequate if the MT utilizes only one BSC for all of its communication. In such a case, the static relationship between the MT and the BSC is critical since the BSC contains the relevant information in order to page another MT. However, in the MEO satellite communications network, this relationship is not at all static, but on the contrary, is dynamic, as mentioned above. Therefore, a need exists for a paging method within a MEO satellite communications network that accounts for the changing relationship between one MT and a plurality of BSCs.

FIG. 1 is an overview of a conventional GSM-GPRS communications network 14. It is important to note the GSM-GPRS communications network does not employ any type of satellite and is therefore a terrestrial network.

Accordingly, various cells 15, 16 and 17 correspond to unique base trans-receiver sub-systems (BTS) 21, 22, and 23. These relationships between the cells 15, 16 and 17 and the corresponding BTSs 21, 22 and 23 are static. Therefore, as the MT 24 changes geographic position from cell 15 to cell 16, the MT 24 communicates with an associated BTS 21, 22 and 23 based upon the MT's 24 cell location. Thus, the MT 24 is the only dynamic component of the GSM-GPRS communications network 14, whereas the cells 15, 16, and 17 and the BTSs 21, 22 and 23 maintain a static association.

A BTS, such as BTS 21, controls transmission for an MT 24 within its cell 15. In addition, the BTS 21 communicates with a base station controller (BSC) 35, that is associated with a unique support GPRS serving node (SGSN) 31. The BTS 21, and BSC 35 collectively form a Base Station System. Accordingly, an MT 24 within a cell 15, corresponding to a unique geographic area, communicates via an associated Base station system (BSS) 36. The BSS 36 comprises a BSC 35 and a BTS 21. The BSS 36 thus corresponds to a unique SGSN 31. This implies that there is a one to one mapping between a BSS and a SGSN.

A conventional terrestrial GPRS network faces various issues that the network is unable to overcome, within a MEO satellite environment, for example. Among the issues are, the fact that regulatory restrictions requiring data originating from a particular region to pass through a specified SGSN, and the radio resources from different satellites are controlled by different base stations physically located in varying regulatory jurisdictions. The issues further comprise the dynamic nature of non-geostationary satellites and their associated spot beams despite the MT remaining static, and the MT's location is illuminated by spot beams from various satellites, as well as the MT's ability to communicate with any of the visible satellites within the network. Therefore a need exists for a network between base stations to facilitate routing communication signals between the base stations, implying a one-one mapping between the base stations and the SGSN.

### SUMMARY OF THE INVENTION

An aspect of the present invention is to provide a system and method which enables efficient communication, via an inter-base station controller network, between a plurality of mobile terminals within a communications network.

Another aspect of the present invention is to provide a doublet comprising <TLLI, SGSN-ID> in order to uniquely identify the user and allow the BSC to route data packets from the MT to the registered SGSN, based upon this doublet.

Another aspect of the present invention is to provide a routing table to facilitate communication between an anchor base station controller (BSC) and a mobile terminal (MT), as well as its associated radio BSC in a communications network. In order to meet certain regulatory requirements in many systems.

Another aspect of the present invention is for the MT to assist the BSC in routing packets based on the geographical position of the MT or the MT location previously registered with the SGSN.

Yet another aspect of the present invention is to provide a system and method for the SGSN to transmit to the MT its position as well as the SGSN ID with which the MT is registered.

A further aspect of the invention is to provide a system and method to deny service based on geographical position of the MT or its International Mobile Subscriber Identity (IMSI).

An additional aspect of the invention is to provide a system and method that will efficiently page the MT depending on whether the MT is in MM-Ready state or MM-Standby state.

Another aspect of the invention is to provide a signaling mechanism between base stations that will allow databases with in the BSC to be cleared when an MT performs a Routing Area Update due to the MT's movement outside its initial routing area.

Finally an aspect of the invention is to provide a system and method of storing a list of Routing Area Identities (RAI) that will assist the MT in a MEO satellite environment to determine when a Routing Area Update is necessary—such a scheme significantly reduces the satellite spectrum usage.

These and other objects are substantially achieved by a system and method for communicating between a plurality of base station controllers within a communications network. One of the base station controllers, corresponding to a support node identifier, processes a communication signal from one of a plurality of mobile terminals accessing the communications network. The mobile terminals are located within a geographic area. The base station controller receives the communication signal from a mobile terminal, and frames the communication signal with a support node identifier bit.

The above objects can further be substantially achieved by a method and apparatus for communicating between a plurality of base station controllers within a communications network. One of the base station controllers corresponding to a support node identifier processes a communication signal from one of a plurality of mobile terminals accessing the communications network. The mobile terminals are located within a geographic area. The method and apparatus employ a plurality of base station controllers corresponding to a plurality of mobile terminals and an interbase station controller network, to enable the network to facilitate high speed communication between the mobile terminals.

### BRIEF DESCRIPTION OF THE DRAWINGS

These and other objects, advantages and novel features of the invention will be more readily appreciated from the following detailed description when read in conjunction with the accompanying drawings, in which:

FIG. 1 depicts an overview of a conventional GSM/GPRS Cellular Network;

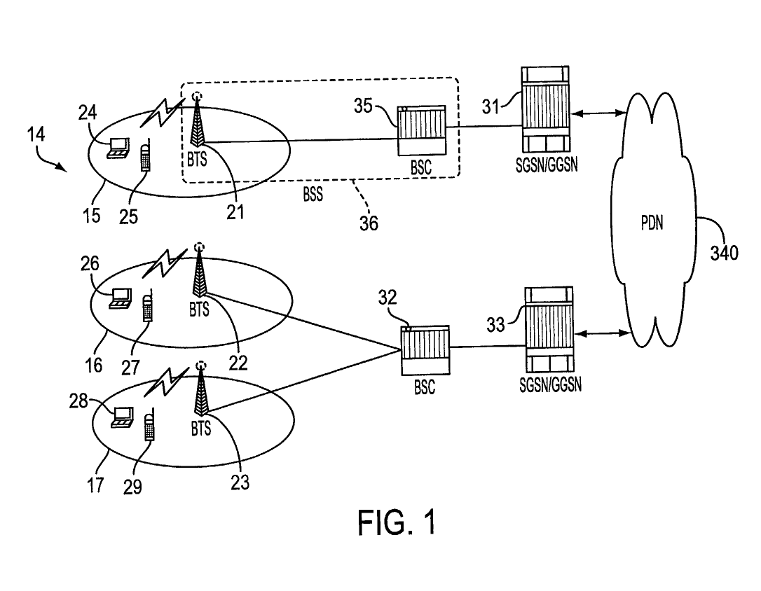

FIG. 2 depicts an overview of a MEO satellite communications network arranged in accordance with an embodiment of the present invention;

FIG. 3 depicts a more detailed block-diagram illustration of the MEO satellite communications network shown in FIG. 2, having connectivity between multiple Base Station Controllers arranged in accordance with an embodiment of the present invention;

FIG. 4 demonstrates multiple Base Station Systems' spot beams projected upon a geographical area controlled by a single SGSN in accordance with an embodiment of the present invention;

FIG. 5 illustrates one Base Station Systems' spot beam projected upon multiple geographic areas controlled by multiple SGSNs in accordance with an embodiment of the present invention;

FIG. 6 is a ladder diagram depicting an example of the communication between an SGSN, mobile switching center, a mobile terminal, and multiple base station controllers in accordance with an embodiment of the present invention;

FIG. 7 depicts a packet data unit with a logical link controller and associated fields, in relation to a ladder diagram illustrating communication between the mobile terminal, the base station controller, and the support GPRS node in accordance with an embodiment of the present invention;

FIG. 8 illustrates a flow diagram of the network updating a Mobile terminal's position in accordance with an embodiment of the present invention;

FIG. 9 depicts a scenario in which Routing Area (RA) Update procedures are executed for the MEO satellite communications network and the associated information relating to a particular user employing radio and anchor base stations in accordance with an embodiment of the present invention;

FIG. 10 illustrates other elements in the network such as the Mobile Switching Center/Visitor Location (MSC/VLR) which assists in mobility management in accordance with an embodiment of present invention;

FIG. 11 depicts the MT switching from one satellite to another satellite, due to local blockage conditions and therefore switching satellite access gateways constructed in accordance with an embodiment of the present invention; and

FIG. 12 depicts a satellite beam movement with reference to time during a routing area update in accordance with an embodiment of the present invention.

### DETAILED DESCRIPTION OF THE INVENTION

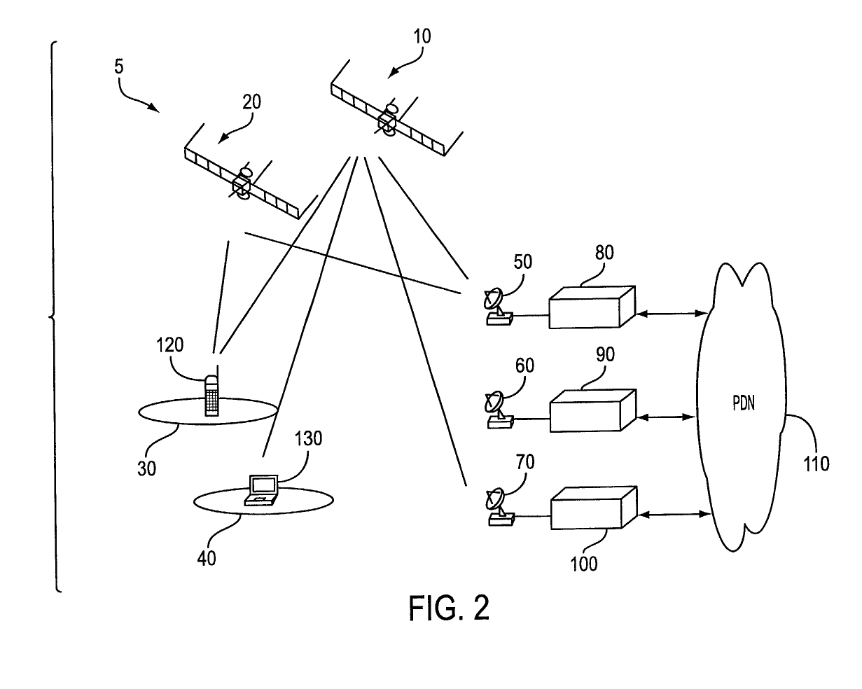

FIG. 2 is an overview of a MEO satellite-based communications network 5 employing an embodiment of the present invention. The network 5 comprises at least two satellites 10 and 20, multiple base trans-receiver systems (BTS) 50, 60 and 70, multiple satellite access gateways (SAG) 80, 90, 100, a public data network (PDN) 110, and various user terminals, for example a mobile telephone 120 and a laptop 130. As the MEO satellites 10 and 20 orbit the earth they project spot beams 30 and 40 onto various geographic regions of the earth, as determined by the satellite orbit. Communication between the various elements, for example the BTS, SAG, and the public Data Network (PDN), is accomplished via a packet switched data transmission service that provides for the transmission of data in the form of packets and switches data at the packet level, in a conventional manner.

When a mobile terminal 120 communicates with another mobile terminal (MT) 130, or the PDN (e.g. internet), the MT's 120 and 130 rely on the spot beams 30 and 40 to transmit and receive messages, via antennas 50, 60 and 70, as well as satellite access gateways (SAG) 80, 90, and 100. Specifically, according to an embodiment of the present invention, a SAG 80 preferably comprises a BSC 350, an SGSN 360 and a GGSN 370.

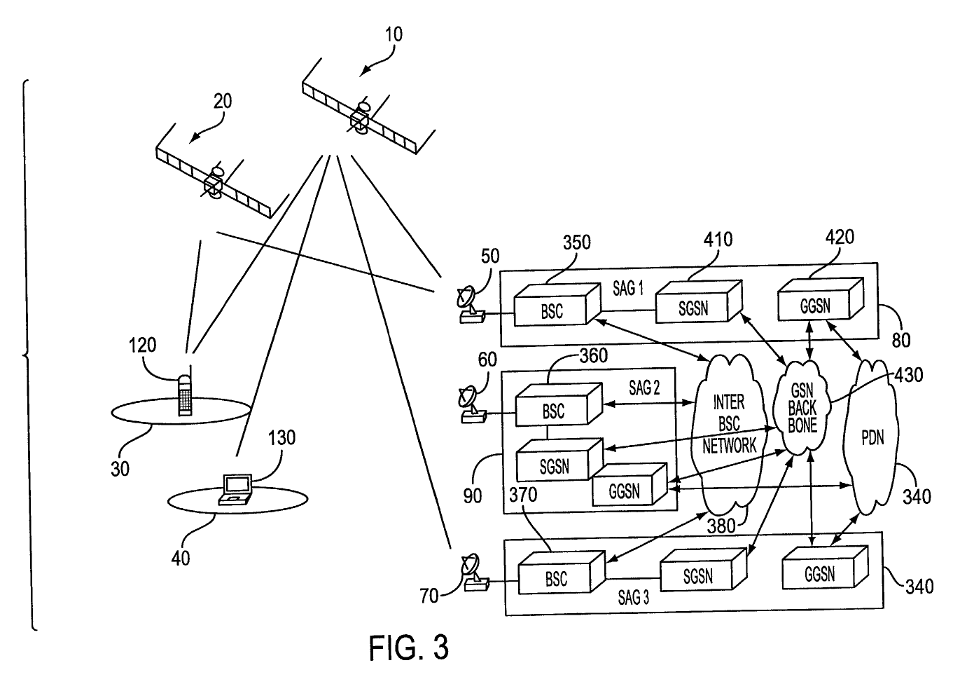

A more detailed depiction of the SAGs 80, 90, and 100 of FIG. 2 is shown in FIG. 3. The BSC 350 has intelligence to enable it to assist the network in executing handoffs, routing and paging, among other functions. In addition, the SGSN 360 and the GGSN 370 serve as a gateway to route PDUs (packet data units) through to various external networks, such as the PDN 340.

It is to be understood that according to another embodiment of the present invention, the SGSN 410 and the GGSN 420 can be considered as one unit. The combined unit interfaces with outside networks, for example the PDN 340, to facilitate packet data transfers.

These aspects, in addition to the regulatory requirements, mentioned below, that a user in a particular geographical region communicates with a particular SGSN, requires a fully connected configuration between the BSCs and SGSNs. Therefore, an embodiment of the present invention preferably provides for a high speed inter-BSC network 380 in accordance with an aspect of the present invention as shown in FIG. 3. This network 380 maintains a high speed connection between multiple BSCs 350, 360 and 370. The network 380 allows the MT 120 and 130, located in separate spot beams 30 and 40 respectively, to communicate via BSCs 350 and 370, over the network 280. The details of the communication signaling, for example handover, and paging, are discussed below. In addition, the GSN backbone 400, and the PDN 340 provide an external gateway (PTSN) to the SGSN 410, and the GGSN 420.

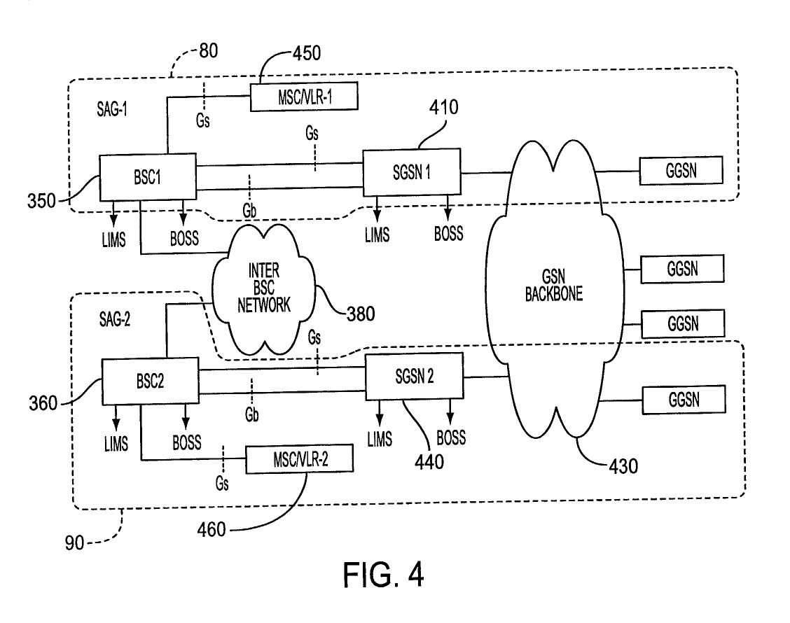

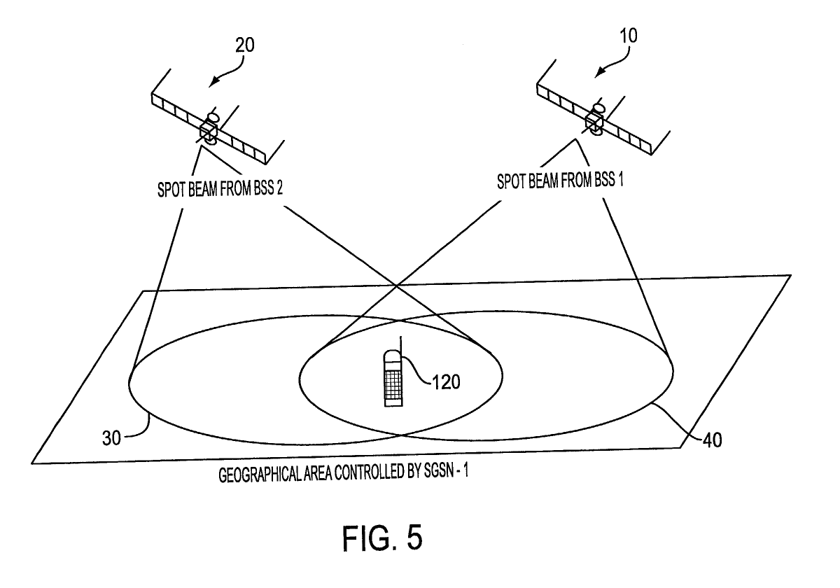

The MEO satellite environment has multiple spot beams, corresponding to multiple satellites, that project onto a mobile terminal, as shown in FIG. 4. A mobile may choose any spotbeam depending on a “goodness” criterion, for example, as determined by the quality of the signal as received by the MT 120 over the broadacast common control channel (BCCH) of a spot beam 40 from the satellite 10. In addition, multiple base stations control the various spot beams. Furthermore as shown in FIG. 4, the spotbeam 40 is so large that the geographical area covered by a spotbeam 40 is under the control of two different SGSNs 42 and 44. However, due to various regulatory requirements a specific SGSN may be employed. The regulatory requirements relate to the fact that there are two satellites 10, 20 visible to an MT 120 where each satellite is controlled by a different BSC physically located in two different countries. The MT can choose to communicate via any of the two satellites 10, 20 depending on a “goodness” criterion, as defined above, and hence any of the two BSCs. However the regulatory requirements provide that regardless of the base station that the MT 120 communicates with, the MT 120 has to communicate with a particular SGSN depending on the geographical location of the MT 120. For example, if an MT is in the USA and is communicating via a satellite controlled by a BSC in Mexico, the MT employs the BSC in Mexico based upon a goodness criteria, the regulatory requirement mandates the BSC in Mexico to route the packets to and from the MT 120 via the SGSN-2 in the USA and not via the SGSN-1 in Mexico of FIG. 5.

The MT 120 of FIG. 4 is within the range of both satellites 10 and 20. However, satellites 10 and 20 are associated with two different base station systems (BSS), BSS1 and BSS2 although MT 120 is within a geographical area controlled by a single SGSN. The MT 120 communicates with the spot beam that is more readily available for communication. Specifically, if satellite 20 is blocked from the view of the MT 120, the MT 120 communicates with satellite 10. Due to the regulatory requirements discussed above, routing is provided to the appropriate SGSN via the concept of a doublet.

Accordingly, as mentioned above, the BSC is able to uniquely distinguish an MT through the concept of a doublet (e.g., <SGSN-ID, TLLI>) comprising an SGSN identifier (SGSN-ID) and a temporary logical link identifier (TLLI), which is unique within a particular SGSN. These doublets allow the BSC to manage two different users having the same TLLI, yet registered with different SGSNs.

The SGSN-ID field of the doublet is preferably provided to the MT by the SGSN at the time of initial registration, or contact, and during routing area updates, for example when the MT moves from one geographic location to another. This SGSN-ID is used by the MT as the last registered SGSN-ID (LRSI) in future requests for uplink transmissions to assist the BSC in subsequent routing, handoff, and other mobility management issues. In the GSM-GPRS protocol, uplink access is typically employed with a two phase access, whereby the first phase employs a channel request message that informs the network of its intent to perform an uplink data transfer and a second phase of access employs a packet resource request message that provides additional details such as mobile terminal's identity (e.g., TLLI), the amount of data to transfer, its priority, and throughput, for example. The packet resource request message from the MT includes LRSI and TLLI information that assists the BSC in routing data from the MT to the appropriate SGSN based on the LRSI. This functionality is therefore useful after a MT has performed a GPRS Attach or Routing Area Update. It can be appreciated that at the time of the Attach or Routing Area Updates, packet routing is based on the geographical location referred to as a Service Area of the MT to meet the regulatory requirements mentioned above. This implies that the BSC has to route certain messages from the MT based on Service Area and others based on LRSI. The MT in accordance with an embodiment of the present invention transmits an associated SA/LRSI bit with the above mentioned doublet to perform appropriate routing. For very short uplink transfers such as Attach Request, the terrestrial GPRS standard employs a single phase access. However, the present invention allows the MT's identifier bit, the TLLI for example, to be transmitted as part of the Medium Access Control/Radio Link Control (MAC/RLC) block. Therefore, in a preferred embodiment of the present invention, for single phase access, the TLLI, LRSI, and SA/LRSI bits are transmitted in the MAC/RLC block.

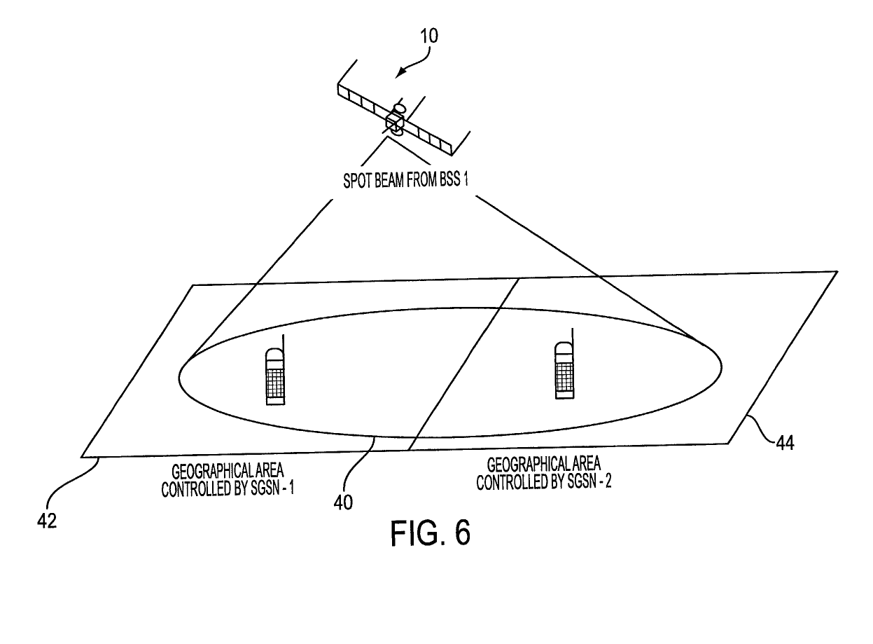

FIG. 6 illustrates an example of routing packet resource requests between multiple BSC's depending upon the MT's location and Service Area (SA). The transmitting MT sends a Channel Request message on the random access channel (RACH) to the BSS which controls the spotbeam that the MT has selected. Based upon reception of a Channel Request 901 message on the RACH channel, BSC2 determines the Service Area wherein the MT belongs. In addition, the network provides a block of uplink resources to the MT. Employing this block of resources, the MT sends an Attach Request 900 to the BSC2. The SA/LRSI bit is also transmitted by the MT in the Medium Access Control/Radio Link Control (MAC/RLC) block. For the case of the Attach Request Message, the MT instructs BSC2 using the SA/LRSI bit to route the Attach Request Message based on the SA. Employing the SA information, BSC2 determines that the MT should register with a different SGSN connected to BSC1, as opposed to the SGSN coupled to BSC2, and therefore routes the Attach Accept to BSC1 which in turn routes the Attach Request Message to SGSN1, or the SGSN directly attached to BSC1. BSC1 is referred to as the anchor BSC as it corresponds to the SGSN to which the user is to be attached. Additionally, the BSC2 is referred to as the radio BSC corresponding to the spotbeam selected by the MT.

When anchor BSC1 receives Attach Request Message from BSC2, BSC1 creates an entry in a routing table for the user based on the TLLI. This context information is used by BSC1, anchor BSC, to appropriately route to BSC2, radio BSC, whenever BSC1 receives data for this particular user.

In FIG. 6, SGSN1 sends Attach Accept Message to BSC1, anchor BSC, as depicted within block 910. BSC1, based on the routing table it had created earlier, routes the Attach Accept to BSC2, the radio BSC. It was also described that the MT position, its accuracy and SGSN-ID is provided to the MT at the time of Attach Accept Message. In accordance with an embodiment of the present invention, anchor BSC (BSC1) appends the MT position, its accuracy and SGSN-ID (in this example SGSN1 ID) to the Attach Accept Message at the end of a logical link controller packet data unit (LLC PDU) containing this message before transmitting it to BSC2, radio BSC. It would be spectrally inefficient to do this for all LLC PDUs; therefore it is important that this appending of the MT position, accuracy, and associated SGSN-ID preferably done at the time of Attach Accept and Routing Area Update. Accordingly, this implies the need for the BSC to recognize these messages.

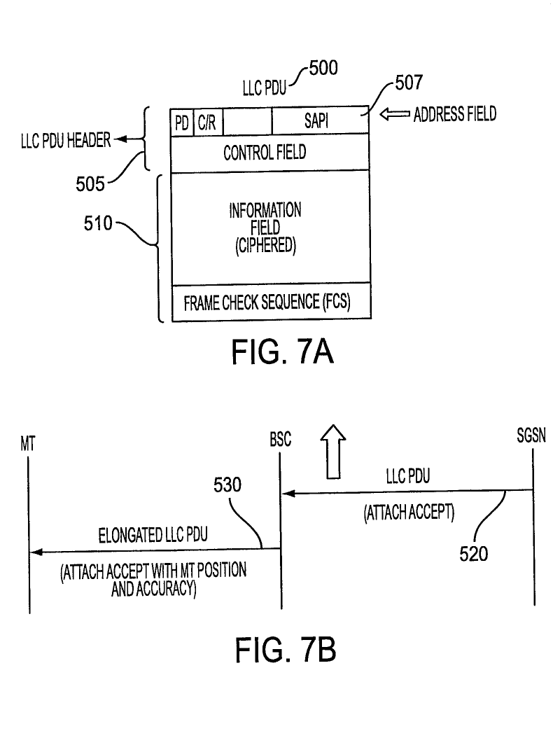

Turning now to FIG. 7, it is noted that LLC PDUs from the SGSN arrive in ciphered or encrypted form as shown in field 510. This makes it difficult for the BSC to make a judgement as to whether it is an Attach Accept or not. BSC1 therefore inspects the LLC header from SGSN (LLC header is not ciphered) and only elongates the LLC PDU for those LLC frames that indicate SAPI=GMM. As shown in FIG. 7, field 505 is not encrypted, whereas field 510 may be encrypted. The elongated LLC PDU is then transmitted to BSC2. The elongation of LLC PDU in accordance with the present invention is illustrated in FIG. 7B.

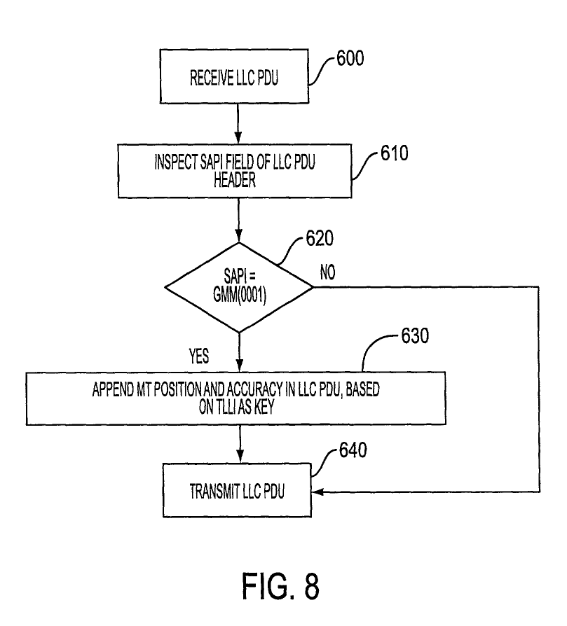

The method of inspecting the LLC header and deciphering those headers with SAPI=GMM is illustrated by the flowchart in FIG. 8. The BSC 350 appends the LLC PDU with the MT position and accuracy, as depicted in FIG. 7. The BSC 350 receives the LLC PDU from the SGSN 410 as shown in block 600. The BSC 350 inspects the SAPI field to determine if SAPI=GMM (0001) 610. If the address field is correct as in block 620 the next step is to attach the MT position and accuracy to the LLC PDU field, as in block 630. As shown in step 640, the LLC PDU field is transmitted to the BSC 350 for processing.

To further protect the information regarding MT position and accuracy from channel errors, a checksum is associated with the appended information in the preferred embodiment. In another embodiment of the present invention, the MT ignores the content of elongation of LLC PDU when a GMM message is not an Attach Accept or Routing Area Update Accept message, for example.

In order to establish proper routing of the communication signal, the SGSN 410 frames the LLC PDU with an Attach Accept/Routing Area Update message, as shown in FIG. 7. In accordance with an embodiment of the present invention, the base station controller 350 inspects the Service Access Point identifier (SAPI) portion of the address field, as shown in FIG. 7A. The BSC 350 obtains LLC PDU frame 500 from the SGSN 410. The BSC 350 processes the header portion of the LLC PDU 505. If the address field contains SAPI=GMM (0001) the BSC 350 transmits the elongated version of the LLC PDU 530 containing the MT Position and accuracy. The ciphered information field 510 comprises the content portion of the communication signal. If the LLC PDU frames with SAPI=GMM are transmitted in a down-link direction, the BSC 350 adds a Cyclic Redundancy Checksum (CRC) to ensure the MT position and accuracy. If any other frame besides the attach accept or routing area update frame comprises the MT position and accuracy, the MT 120 rejects that information.

An additional function of the BSC employs appending a registration forbidden flag to a SAPI=GMM LLC PDU frame, thus denying service to an MT for a variety of reasons, including but not limited to, the MT's location. In accordance with another embodiment of the present invention, the BSC manipulates all GMM messages from MTs belonging to certain areas or having a particular International Mobile Subscriber Identity (IMSI). This manipulation results in an Attach Reject or Routing Area Update Reject. For example, the manipulation method involves replacing the identity of the user by an IMSI in the Attach Request or Routing Area Update Request Message, wherein the user identified by the IMSI is known to be rejected by the SGSN. Therefore, in accordance with another embodiment of the present invention, the BSC manipulates all GMM messages from those MTs in certain service areas provoking the SGSN to send back an Attach Reject or Routing Area Update Reject.

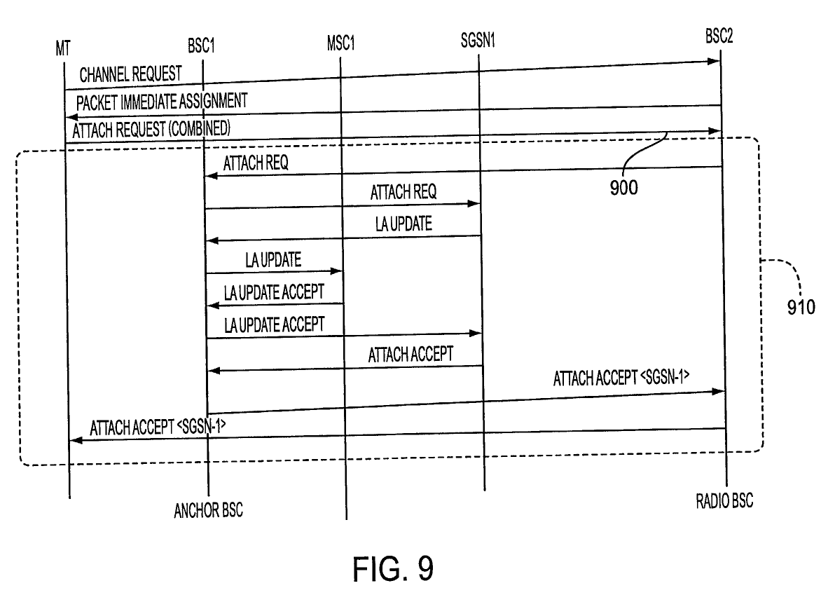

In the dynamic situation of the MEO satellite arena, associated BSCs and SGSNs are changing based upon the MT location, as highlighted in FIG. 9. Specifically, when an MT 120 moves appreciably from one location 920 to another location 930, the associated SAG 940 is no longer controlling the MT 120, rather the SAG 950 controls the MT 120. Accordingly, when the MT 120 changes location it makes a routing area update as detailed above, with its position and accuracy information. If the new MT position 930 is controlled by a different SAG 950, then the LLC PDU is routed to the new SAG 950. According to the to an embodiment of the present invention, when an Routing Area (RA) Update Request is received by BSC in SAG 950, the BSC in SAG 950 sends a message to the BSC in SAG 940 to purge the contents of its routing table for MT 120. The old SAG 940 purges its routing table or contexts associated with the MT 120 upon transmission of the LLC PDU to the new SAG 950. This prevents stale contexts to be retained in the entire system.

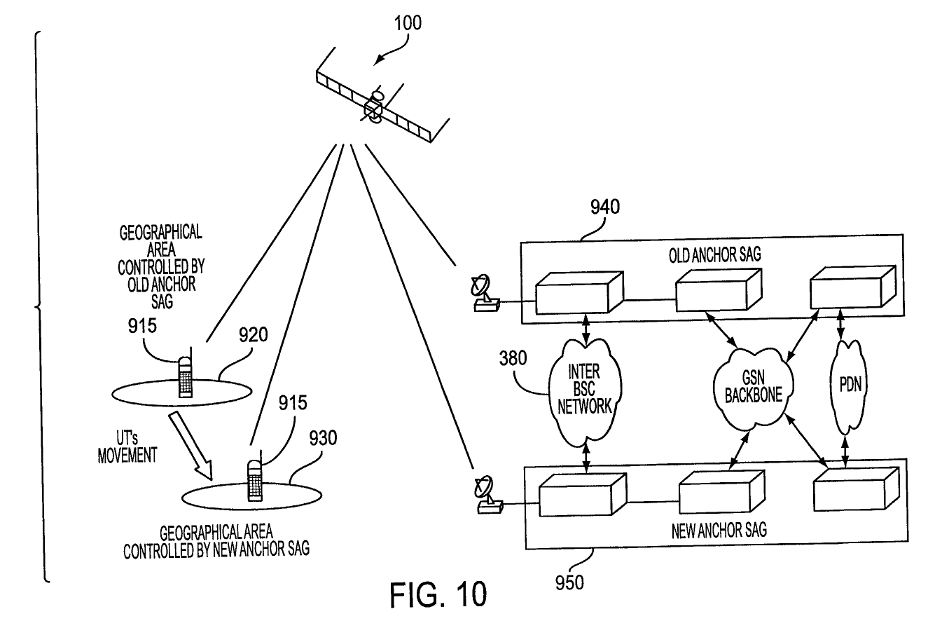

The concept of a MEO satellite communications system managing a paging request from an MT will now be described. An MT 120 is associated with a satellite spot beam 40 that is not directly associated with BSC 350 of FIG. 10. MT 120 may be registered with SGSN 410. When the MT is in MM-Standby state, SGSN 410 does not know which spotbeam the MT is listening to since the SGSN 410 does not know the cell location of the MT 120 but rather the routing area of the MT 120. By contrast to MM-Ready mode, where the SGSN 410 knows exactly which cell contains the MT 120. Accordingly, the BSC 350, based on the MT position finds all the beams covering the MT position and pages the MT in all those beams. Circuit Switched (CS) paging from the Mobile Switching Center/Visitor Location Register (MSC/VLR) 450 can arrive at the BSC 350 during MM-Standby or MM-Ready mode. When the MT is in MM-Ready, then SGSN 410 indicates the Cell Identifier along with Paging CS PDU. According to another embodiment of the invention, the BSC processes this information to determine whether the user needs to be paged only in a single spotbeam, or multiple spotbeams.

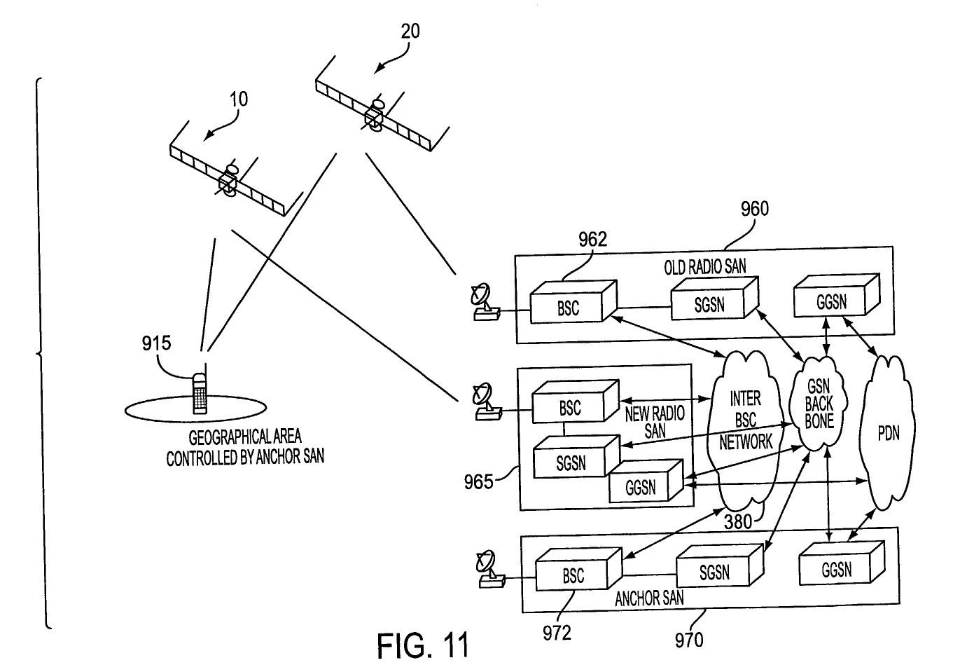

Another embodiment of the present invention, as shown in FIG. 11, depicts the MT 915 ceasing communication with satellite 10 and beginning communication with satellite 20, thus switching from Radio SAG 960 to new Radio SAG 965. During such an event, there are several LLC PDU frames that are pending in the old Radio SAG 960. Instead of consuming resources by maintaining and attempting to transmit these LLC PDU frames from old SAG 960 to an MT that is not listening, a communication link is maintained between the old Radio SAG 960 and the new Radio SAG 965, via the anchor SAG 970. Another embodiment of the present invention comprises the method of the anchor BSC 972 receiving signaling relating to a BSC other than that indicated by the LRSI. In other words, the anchor BSC 972 generates a “Flush LLC Message” to the old radio BSC 962, causing the BSC 962 to purge all pending LLC PDUs. This new method conserves valuable radio resources. The anchor SAG 970 is a vital link between MT 120 and the various radio SAGs 960 and 965. The anchor SAG 970 is the original associated SAG however, due to the communication signal or other dynamic elements of the communication system, various other radio SAGs are involved in transmission of the communication signal.

The above mentioned unplanned handover situation highlights the dynamic nature of the MEO satellite communications network. Despite the fact that an MT is in a stationary position, other components of the communications network, for example the radio BSC, and the anchor BSC, as well as the associated SAGs can change. In addition to these components, the satellites within a MEO satellite network are orbiting the earth at a constant rate, therefore the geographic location of the spot beam is constantly in flux. Accordingly, an MT enters a new spot beam, periodically, even if the MT is stationary. Every time it enters a new spotbeam it is not pageable. Therefore one solution is to continually send Routing Area Update messages to the network, in a conventional manner. However, this consume vital radio resources.

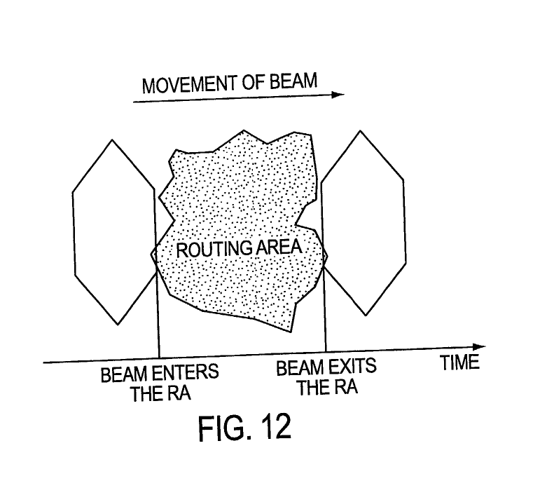

Therefore, another embodiment of the present invention employs a packet data service within each beam that carries a routing area identity information list comprising a time stamp. The time stamp indicates the time after which the beam will no longer be covering the routing area, as shown in FIG. 12. The network of the present invention maintains the time at which a beam enters a routing area and the time at which the beam leaves the routing area As soon as a beam enters a routing area, the broadcast common control channel (BCCH) broadcasts a routing area identity list comprising a geographic region the beam covers, the list is updated with the time stamp of when the beam will leave the routing area, as mentioned above.

The MT downloads the routing area information list comprising the routing area identifier from the network via the BCCH. The MT initiates a timer equal to the difference between the time the beam will leave the routing area as indicated by the routing area identity list, and the current time. When the time elapses the MT initiates a routing area update. Therefore, the MT is aware of which spot beam the MT is employing for communication.

Although only several exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A system for communication between a plurality of base stations via at least one of a plurality of satellites, said system comprising:
a plurality of support node gateways adapted to at least one of receive and transmit communication signals with a plurality of mobile terminals via said base stations; and
a high speed network adapted to at least one of receive and transmit said communication signals between said base stations.

2. A system as claimed in claim 1, further comprising a support node gateway coupling one of said base stations to a network, wherein said support node gateway and one of said base stations corresponding to a geographic area containing said mobile terminal.

3. A system as claimed in claim 2, wherein said support node gateway adapted to communicate with a public data network.

4. A system as claimed in claim 2, wherein said base station comprises:
a radio base station adapted to at least one of receive and transmit said communication signals from said mobile terminal communicating via said satellite; and
an anchor base station adapted to at least one of receive and transmit said communication signals between said radio base station and said support node gateway.

5. A system as claimed in claim 4, wherein said anchor base station further comprises a routing table adapted to route said communication signals to said radio base stations based upon said geographic location of said mobile terminal.

6. A system as claimed in claim 2, wherein said support node gateway adapted to correspond to an assigned geographic area based upon regulatory requirements.

7. A system as claimed in claim 1, wherein said plurality of base station comprising:
an intelligent base station controller; and
a terrestrial trans-receiver controller.

8. A method for updating routing information by a base station associated with a mobile terminal within a communications network, said base station having a corresponding support node gateway for the geographic area in which said base station is located, said method comprising:
transmitting signaling information from said mobile terminal to a first said base station;
processing said signaling information at said base station to determine when said mobile terminal is outside said geographic area corresponding to a first said support node gateway;
indicating to said base station to transmit said location information to a second said base station having a corresponding second said support node gateway when said mobile terminal is outside said geographic area corresponding to a first said support node gateway; and
deleting said location information from said base station of said mobile terminal associated with said first said support node gateway.

9. A method for communicating between a plurality of base stations within a communications network, wherein one of said base stations adapted to correspond to a support node gateway, said base stations comprise a radio base station adapted to at least one of receive and transmit said communication signals from said mobile terminal communicating via said satellite and an anchor base station, said anchor base station adapted to at least one of receive and transmit said communication signals between said radio base station and said support node gateway, and wherein at least one of a plurality of mobile terminals are located within a geographic area corresponding to a support node gateway, said method comprising the steps of:
receiving said communication signal from said mobile terminals;
framing said communication signal at said radio base station with said support node gateway identifier corresponding to said geographic area; and
transmitting said communication signal to said anchor base station corresponding to said support node gateway identifier.

10. A method as claimed in claim 9, said framing step further comprising framing said communication signal with a temporary logical link controller to uniquely identify said mobile terminal.

11. A method as claimed in claim 9, further comprising:
receiving said communication signal at a radio base station controller from one of said mobile terminals;
transmitting said communication signal to a corresponding support node gateway;
receiving said communication signal at said anchor base station from said corresponding support node gateway; and
marking said communication signal of said mobile terminal with a marker at said anchor base station controller.

12. A method as claimed in claim 11, wherein registration comprises said mobile terminal initially communicating with said network, said marking step further comprising:
marking said communication signal with a temporary logical link controller to uniquely identify said mobile terminal and said support node gateway identifier corresponding to a support node gateway comprising said mobile terminal's location at the time of said registration.

13. A method as claimed in claim 9, wherein said communication signal comprises location information from said mobile terminal, said method further comprising:
receiving said communication signal at said radio base station from said mobile terminals;
routing said communication signal from said radio base station to one of said mobile terminals via said support node gateway when said communication signal comprises said support node gateway information, and routing said communication signal to one of said mobile terminals based upon said mobile terminal's geographic location when said communication signal comprises the absence of said support node gateway information.

14. A method as claimed in claim 9, said method further comprising:
denying said mobile terminal access to said communications network by framing said communication signal with a service denial bit at said base station controller;
transmitting said communication signal with a service denial bit to said one of a plurality of mobile terminals; and
interpreting said bit at said mobile terminal to be a failure of an attempt to access said communications network.

15. A method as claimed in claim 14, wherein said service denial bit includes a registration forbidden flag.

16. A method as claimed in claim 9, wherein said geographic area includes a restricted geographic area, said method further comprising:
receiving said communication signal from said one of a plurality of mobile terminals at said one of a plurality of base stations;
manipulating said communication signal based on geographic location of said one of a plurality of mobile terminals; and
transmitting said manipulated signal to said support node gateway corresponding to said geographic location to deny service to said mobile terminal within said geographic location.

17. A method as claimed in claim 16, said manipulating step further comprising:
replacing said mobile terminal's identity with an International Mobile Subscriber Identity wherein said International Mobile Subscriber Identity is rejected, and wherein said communication signal comprises Attach Reject, and Routing Area Update Reject.

18. A method as claimed in claim 9, wherein said at least one of said plurality mobile terminals ceases communication with a first satellite corresponding to a first said radio base station and initiates communication with a second satellite corresponding to a second said radio base station, and a selected ones of a plurality of base stations, said selected ones of said base stations comprising an anchor and a radio base station, wherein said anchor base station corresponding to a mobile terminal and said radio base station corresponding to a spot beam selected by said mobile terminal said method further comprising:
detecting change of transmission from said first satellite to said second satellite at said first radio base station of said communication signal;
transmitting said communication signal comprising deleting instructions from the anchor base station to said first radio base station; and
deleting all pending communication signals waiting to be transmitted to said mobile terminals from the memory of said first radio base station.

19. A method for maintaining a routing table at one of a plurality of base stations to facilitate routing a plurality of communication signals between selected ones of said base stations, said selected ones of said base stations comprising an anchor and a radio base station, wherein said anchor base station corresponding to a mobile terminal and said radio base station corresponding to a spot beam selected by said mobile terminal, said method comprising:
receiving one of said communication signals from said mobile terminal at said anchor base station;
storing said mobile terminal location at said anchor base station when said anchor base station is the same as said radio base station;
routing said communication signal from said anchor base station to said radio base station when said anchor base station is not the same as said radio base station; and
maintaining a routing table at said anchor base station comprising said mobile terminal and corresponding said anchor base station and said radio base station.

20. A method as claimed in claim 19, said maintaining step further comprising:
creating an entry in said routing table for said mobile terminal when it initially communicates with said anchor base station; and
storing the identity and location of said mobile terminal in said table.

21. A method as claimed in claim 19, wherein said entry comprising an Attach Request and a Routing Area Update Request, and said identity of said mobile terminal comprising a temporary logical link controller.

22. A method for communicating the position of one of a plurality of mobile terminals between a selected ones of a plurality of base stations, said selected ones of said base stations comprising an anchor radio base station coupled to a support node gateway, wherein said anchor base station communicating with a mobile terminal and said radio base station corresponding to a spot beam selected by said mobile terminal, said method comprising:
receiving said communication signal at said radio base station controller from said mobile terminal;
processing said communication signal at said radio base station controller transmitted from said mobile terminal to determine said mobile terminal's position;
framing said communication signal at said radio base station controller with bits comprising said mobile terminal's location within a geographic area;
transmitting said communication signal to said anchor base station;
maintaining said bits in memory of the said anchor base station controller; and
extracting said bits of said communication signal from said memory at said anchor base station for transmission to said mobile terminal.

23. A method as claimed in claim 22, wherein said communication signal comprises a header comprising a SAPI field, said method further comprising:
extracting said bits by indexing in a table at said anchor base station with an appropriate mobile identity; and
optimizing the radio resources for spectral efficiency by appending said bits when said header comprises SAPI includes GMM.

24. A method as claimed in claim 22, wherein said bits comprises mobile terminal location information.

25. A method as claimed in claim 22, wherein said bits includes said mobile terminal's position accuracy.

26. A method for processing a mobile terminal's position at said base station, said mobile terminal's position comprising bits with position information, said method comprising:
accepting said position information bits by said mobile terminal from said base station when said bits are attached with communication signals comprising Attach Accept, Routing Area/Location Area Update Accept;
rejecting said position information bits by said mobile terminal when said communication signal from said base station comprises the absence of Attach Accept, Routing Area/Location Area Update Request Accept.

27. A method for paging at least one of a plurality of mobile terminals in at least one of a plurality of spot beams of satellites by at least one of a plurality of satellite access gateways, and wherein said satellite access gateway comprises at least one of said base stations and a corresponding support node gateway, said method comprising:
receiving a page from said one of a plurality of support nodes;
processing said page to determine location of said mobile terminal being paged by said satellite access gateways; and
transmitting said page directly to said mobile terminal when said mobile terminal is active; and
transmitting said page to said at least one of plurality of satellite access gateways when said mobile terminal is inactive.

28. A method as claimed in claim 27, wherein said active includes in MM-Ready Mode and said inactive includes MM-Standby Mode.

29. A method for purging the context of a mobile terminal as a mobile terminal physically moves from a first location to a second location, wherein said first location corresponds to a first anchor base station, and a second location corresponds to a second anchor base station, said method comprising:
receiving a communication signal from said mobile terminal at said second anchor base station;
extracting the identity of said first anchor base station from said communication signal received from said mobile terminal; and
purging said context of said mobile terminal from said first anchor base station by at least one of receive and transmit said communication signals between said first and said second anchor base stations.

30. A method as claimed in claim 29, wherein said context comprises a routing table, said mobile terminal's position, said mobile terminal's identity, and said mobile terminal's corresponding spot beam.

31. A method to determine when to update a routing area identity information list comprising a time stamp, wherein a mobile terminal downloads said routing area identity information from a satellite via a communication signal within a communications network to determine when said mobile terminal is within said satellite spot beam, said method comprising;
transmitting said communication signal from base station to said satellite for re-transmission to a plurality of said mobile terminals, said signal comprising timing information when said satellite spot beam will encompass different routing areas;
initiating a timer at said mobile terminal comprising the difference between a current time and the timing information corresponding to mobile terminal's known routing area;
downloading said re-transmitted said communication signal from said satellite while said timer has not expired; and
triggering a Routing Area update when said timer expires.

32. A method as claimed in claim 31, said triggering step further comprising triggering a routing area update when said mobile terminal changes geographic location said mobile terminal communicates via a new satellite spot beam, and said communication signal comprises the absence of said mobile's routing area information from said new satellite spot beam.
